(19) United States
(12) Patent Application Publication
(10) Pub. No.: US 2003/0147534 A1
(43) Pub. Date: Aug. 7, 2003

(54) Method and apparatus for in-vehicle device authentication and secure data delivery in a distributed vehicle network

(76) Inventors: Sewim F. Ablay, West Dundee, IL (US); Ronald G. Akers, Palatine, IL (US); Ezzat A. Dabbish, Cary, IL (US); Mark A. Gannon, Sleepy Hollow, IL (US); Donald J. Remboski, Dearborn, MI (US); Bryan Thale, Algonquin, IL (US)

Correspondence Address: MOTOROLA, INC., 1303 EAST ALGONQUIN ROAD, IL01/3RD, SCHAUMBURG, IL, 60196

(21) Appl. No.: 10/068,401

(22) Filed: Feb. 6, 2002

(51) Int. Cl. H04L 9/00

(52) U.S. Cl. 380/270; 713/170

(57) ABSTRACT

A telematics communication system (100) includes an infrastructure (140) and a vehicle (102), the vehicle including at least one in-vehicle system (104, 118) and a wireless gateway (120) in communication with an authenticated vehicle gateway (108). The authenticated vehicle gateway authenticates the wireless gateway and the at least one in-vehicle system and processes service requests and authenticated service grants for the authenticated wireless gateway and the authenticated in-vehicle system.

### FIELD OF THE INVENTION

This application relates to telematics including, but not limited to, authentication of user-installable devices and support for end-to-end, distributed applications.

### BACKGROUND OF THE INVENTION

Many automotive vehicles have both a vehicle bus and a user bus. Typically, the user bus supports various user devices or systems, such as a cell phone, a radio frequency (RF) data device, a pager, an entertainment system, and a global positioning satellite (GPS) receiver. The vehicle bus typically supports various vehicle devices or systems, such as a motive power source (for example, an internal combustion engine or an electric engine, or a hybrid internal combustion and electric engine), an instrument display, door locks, and flashing lights. The vehicle bus also includes proprietary information and safety-related information, such as an anti-theft system computer program or an anti-lock braking system computer program. Generally, the user bus is not directly coupled to the vehicle bus but is instead coupled to the vehicle bus by means of a vehicle gateway.

Wireless devices connected to a user bus, such as cell phones and RF data devices, may also function as “wireless gateways” that provide wireless connectivity between the vehicle bus, and devices or systems coupled to the vehicle bus, and remote (off-vehicle) entities and/or devices coupled to the user bus. For an in-vehicle device or system coupled to the vehicle bus or the user bus to participate in a wireless connection, the participating in-vehicle device or system must be authenticated. However, vehicles are commonly manufactured as “minimum configuration,” that is, the vehicle, as manufactured, has only a vehicle gateway and an “unpopulated” user bus. User devices (either OEM or “aftermarket”) may then be added to the user bus at a later time. This presents a problem of authentication of such subsequently added devices or systems. Authentication is sometimes confused with “encryption.” In contradistinction to authentication, encryption is an act or process of ensuring the privacy of a communication by applying a secrecy mechanism or process which operates on individual characters or bits of the communication independent of the semantic content. The resulting encrypted communication, called “cyphertext,” can then be stored, transmitted, or otherwise exposed without also exposing the secret information hidden within. This means that cyphertext can be stored in, or transmitted through, systems which have no secrecy protection.

As can be seen from the definitions above, authentication is concerned with establishing identity while encryption is concerned with maintaining privacy or secrecy. The mere fact that an encrypted message may be successfully decrypted by the recipient does not establish the identity of the sender of the message. For example, an attacker may record an encrypted transmission and then retransmit it at a later time (also known as a “replay attack”, to be referenced below). The recipient will be able to decrypt both the original message and the attacker's retransmitted copy. In the absence of authentication, the recipient will accept and act upon both transmissions even though the retransmission was made by the attacker and not the original sender. It is not necessary for the attacker to be able to decrypt and understand the message in order to attack the recipient with it.

Vehicle systems such as engine controllers can be considered as “thin clients”, or devices with very limited computing resources (memory, computing power, etc.). As such, these devices usually do not have sufficient processing capabilities to support an authentication mechanism. In addition, vehicle manufacturers desire to retain a capability to select and certify certain suppliers of vehicle or user devices or systems and the devices and systems that may be allowed to operate on the user bus. As a result, vehicle manufacturers do not want to permit suppliers of subsequently added devices and systems to manufacture authenticated devices and systems.

However, in order for a minimum configuration vehicle with subsequently added devices and systems to participate in a wireless communication, at least one entity in the vehicle must be deemed to be a “trusted entity” by the vehicle manufacturer at time of vehicle manufacture. Typically, the trusted entity is the vehicle gateway, which gateway includes a ‘vehicle manufacturer public key.’ However, due the recent evolution of telematics as a means for providing wireless communication between in-vehicle systems and systems external to the vehicle, the issue remains of how to authenticate the subsequently added devices and systems for participation in a wireless communication. Furthermore, the wireless gateway also may be replaced in a vehicle, creating the problem of authenticating a vendor's wireless gateway and allowing the vendor's gateway to operate and communicate with vehicle manufacturer gateways and in-vehicle systems and devices.

Therefore a need exists for a method and apparatus for authentication that permits participation in a wireless communication of later added devices and systems while allowing the vehicle manufacture to control whose systems and device may be used in the vehicle. In addition, a need exists for a method and apparatus for authenticating a vendor's wireless gateway and allowing the vendor's gateway to operate and communicate with vehicle manufacturer gateways and in-vehicle systems and devices, again while allowing the vehicle manufacture to control what vendors' gateways may be used in the vehicle.

### BRIEF DESCRIPTION OF THE DRAWINGS

FIG. 1 is a block diagram of a telematics communication system in accordance with an embodiment of the present invention.

FIG. 2 is a block diagram of a software architecture of the telematics communication system of FIG. 1 in accordance with an embodiment of the present invention.

FIG. 3 is a signal flow diagram of a signature generation and verification process in accordance with an embodiment of the present invention.

FIG. 4 is block diagram of a wireless gateway manufacturer public key certificate, wireless gateway public key certificate, and a wireless gateway -signed message in accordance with an embodiment of the present invention.

FIG. 5 is a logic flow diagram of steps by which a remote person or entity can wirelessly reprogram a system contained in the vehicle of FIG. 1 in accordance with an embodiment of the present invention.

FIG. 6 is a logic flow diagram of steps by which a vehicle gateway of FIG. 1 processes a received service request in accordance with an embodiment of the present invention.

FIG. 7 is a logic flow diagram of steps executed by an application running in the infrastructure of FIG. 1 in sending executable software to the vehicle gateway of FIG. 1 in accordance with another embodiment of the present invention.

### DETAILED DESCRIPTION OF THE INVENTION

To address the need for a method and apparatus for authentication that permits participation in a wireless communication of later added devices and systems while allowing the vehicle manufacture to control whose systems and devices may be used in the vehicle, and the need for a method and apparatus for authenticating a vendor's wireless gateway and allowing the vendor's gateway to operate and communicate with vehicle manufacturer gateways and vehicle subsystems, again while allowing the vehicle manufacture to control what vendors' gateways may be used in the vehicle, a telematics communication system is provided that includes an infrastructure and a vehicle. The vehicle includes at least one in-vehicle system and a wireless gateway in communication with an authenticated vehicle gateway. The authenticated vehicle gateway authenticates the wireless gateway and the at least one in-vehicle system and processes service requests and authenticated service grants for the authenticated wireless gateway and the authenticated in-vehicle system.

Generally, one embodiment of the present invention encompasses a method for authentication of an entity in a motive vehicle by a trusted gateway residing in the vehicle, wherein the entity is either one of a gateway or a vehicle system. The method includes steps of receiving a request for service for the entity, determining whether the entity is an authenticated entity; and when the entity is not an authenticated entity, authenticating the entity to produce an authenticated entity.

Another embodiment of the present invention encompasses an apparatus for authenticating an entity in a vehicle. The apparatus includes a first, trusted entity residing in the vehicle that receives a service request from a second entity residing in the vehicle, determines whether the second entity is an authenticated entity in response to the request, and when the second entity is not an authenticated entity, authenticates the second entity to produce an authenticated entity.

In yet another embodiment of the present invention, in a vehicle in wireless communication with an infrastructure, an apparatus includes a first, trusted entity residing in the vehicle and a second entity residing in the vehicle and in communication with the trusted entity. The trusted entity receives a service request, determines whether the second entity is an authenticated entity in response to the service request, and, when the second entity is not an authenticated entity, authenticates the second entity to produce an authenticated entity.

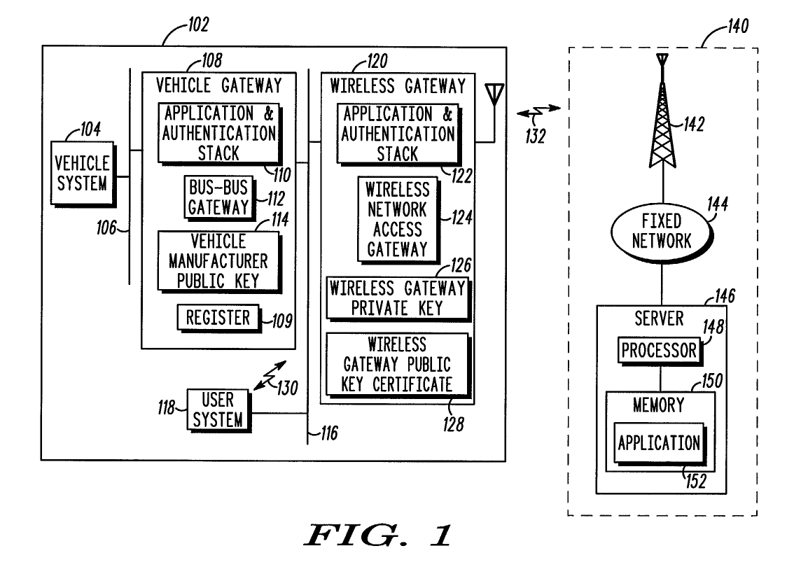

The present invention may be more fully described with reference to FIGS. 1-7. FIG. 1 is a block diagram of a telematics communication system 100 in accordance with an embodiment of the present invention. System 100 includes an automotive vehicle 102, such as a car, a bus, or a truck, in wireless communication with a wireless communication infrastructure 140. As depicted in FIG. 1, vehicle 102 includes a first vehicle system 104, preferably a vehicle device or system, that is operably coupled to a vehicle bus 106. Vehicle 102 further includes a second in-vehicle system 118, preferably a user device or system, and a wireless gateway 120 that are each operably coupled to a user bus 116. Vehicle 102 further includes a vehicle gateway 108 is operably coupled to each of vehicle bus 106 and user bus 116. Those who are of ordinary skill in the art realize that other configurations of vehicle gateway 108, and wireless gateway 120 may be used herein without departing from the spirit and scope of the present invention. For example, vehicle gateway 108 and wireless gateway 120 may be configured in a single entity and linked to vehicle device or system 104 via vehicle bus 106 and to user device or system 118 via user bus 116.

Vehicle device or system (hereinafter referred to as a “vehicle system”) 104 includes a processor and an associated memory (not shown) that stores information concerning a status of the vehicle system. The vehicle system status may include, for example, one or more of a current date, a current time, a current location of the vehicle, a current mileage of the vehicle, a vehicle identification number, a current age of the vehicle, an on/off status of the vehicle, billing information, account information, user information, a current hardware version, a current software version, and the like.

Vehicle gateway 108 includes a processor and an associated memory (not shown) that stores programs and applications that permit the vehicle gateway to perform the functions herein, and a register 109 that stores a list of authenticated devices included in vehicle 102. Vehicle gateway 108 further includes an application and authentication stack module 110 and a bus-bus gateway 112 that are each preferably implemented in the processor of vehicle gateway 108. Application and authentication stack module 110 provides authentication services to vehicle gateway 108 and executes applications stored in the vehicle gateway. Bus-bus gateway 112 provides routing services for data packets received from vehicle bus 106 and to be routed over user bus 116 and for data packets received from user bus 116 and to be routed over vehicle bus 106.

At the level of interconnected networks systems, such as system 100, understandings known as protocols have been developed for the exchange of data among multiple users of the networks. The protocols specify the manner of interpreting every data bit of a data packet exchanged across the networks. In order to simplify network designs, several well-known techniques of layering the protocols have been developed. Protocol layering divides the network design into functional layers and then assigns separate protocols to perform each layer's task. By using protocol layering, the protocols are kept simple, each with a few well-defined tasks. The protocols can then be assembled into a useful whole, and individual protocols can be removed or replaced as needed. A layered representation of protocols is commonly known as a protocol stack. In this context, an “authentication stack,” as described below, is a specialization of a protocol stack.

Vehicle gateway 108 is deemed a trusted entity for security and authentication purposes, since it may be the only entity that may be originally built into vehicle 102, as manufactured. As described in greater detail below, vehicle gateway 108 can be used to authenticate other entities in vehicle 102, such as vehicle system 104, wireless gateway 120, and user device or system 118, which entities, once authenticated, may make service requests of the vehicle gateway. As known to those skilled in the art, gateways may be authenticated as often as appropriate; typically, authentication is done either on a per-session basis or upon power-up of the gateway. Vehicle gateway 108 also executes functions and caches data that may be used by applications that may be executed by each of vehicle system 104 and user system 118. Vehicle gateway 108 obtains information concerning the functions and applications corresponding to vehicle system 104 or user system 118 by requesting the information from the system or device, for example, via a polling process, or by being conveyed the information when the system is connected to the vehicle bus 106. Vehicle gateway 108 also stores a vehicle system format that includes the functionality corresponding to one or more vehicle systems, thus forming a gateway vehicle system registration function. Vehicle gateway 108 further stores a vehicle manufacturer cryptographic public key 114 that is described in greater detail below and that is used to generate random numbers 407, 408 that support the below described processes of authenticating wireless gateway 120 and user system or device 118.

Wireless gateway 120 includes a processor and an associated memory (not shown) that stores programs and applications that permit the wireless gateway to perform the functions herein. Wireless gateway 120 further includes an application and authentication stack module 122 and a wireless network access gateway 124 that are each preferably implemented in the processor of wireless gateway 120. One of the programs stored and executed by wireless gateway 120 is an application that supports a process by which vehicle gateway 108 authenticates the wireless gateway. In support of the authentication process, wireless gateway 120 formulates service requests, generates the appropriate random numbers, and stores a wireless gateway cryptographic public key certificate 128 that is signed by a manufacturer of the wireless gateway, along with a corresponding wireless gateway private key 126. Wireless gateway 120 also accepts service requests from remote applications running in infrastructure 140 and, once authenticated, can request services from vehicle gateway 108, such as accessing vehicle system 104 via vehicle bus 106.

User system or device 118 (hereinafter referred to as “user system 118”) is a device or system with which the vehicle user or operator, or a system in the vehicle, can interact. User system 118 may be permanently mounted in the vehicle or may be removable by a user. For example, user system 118 may be a laptop computer, a PDA, a cellular telephone, a web server, a text-to-speech synthesizer (TTS), a speech recognition unit, a navigation system, and the like. User System 118 may also be composed of multiple functional entities, for example, a display and a processing unit, connected by user bus 116. User system 118 may also have InfraRed or short-range wireless capabilities, such as “Bluetooth” capabilities, that access wireless gateway 120 via a local link 130. User system 118 and vehicle system 104 are each also capable of storing and executing programs that support processes by which the respective user system and vehicle system is authenticated. In support of the authentication process, user system 118 is capable of formulating service requests, generating appropriate random numbers, and storing a cryptographic public key certificate. Also, once authenticated, user system 118 can request services from vehicle gateway 108, from infrastructure 140 via wireless gateway 120, or from both the vehicle gateway and the infrastructure. The services that can be requested by user system 118 include accessing the vehicle system 104 via vehicle bus 106, user bus 116, and vehicle gateway 108.

Wireless communication infrastructure 140 includes a base station 142 coupled to a fixed network 144 that, in turn, is coupled to a network server 146. Network server 146 may be operated under the control of a manufacturer of vehicle 102 and stores manufacturer information and exchanges the information with vehicles built by the manufacturer. Network server 146 includes a processor 148 and an associated memory 150 that stores programs and applications, for example application 152, that are capable of being executed by the processor. Memory 150 further stores information provided to server 146 by the vehicle manufacturer. Infrastructure 140 communicates with wireless gateway 120 by means of a radio frequency (RF) communication link 132. Wireless gateway 120 may also wirelessly communicate directly with user system 118 via link 132, such as when the user system is a radio frequency (RF) communication device such as a cellular telephone, a radiotelephone, or an RF capable personal digital assistant (PDA).

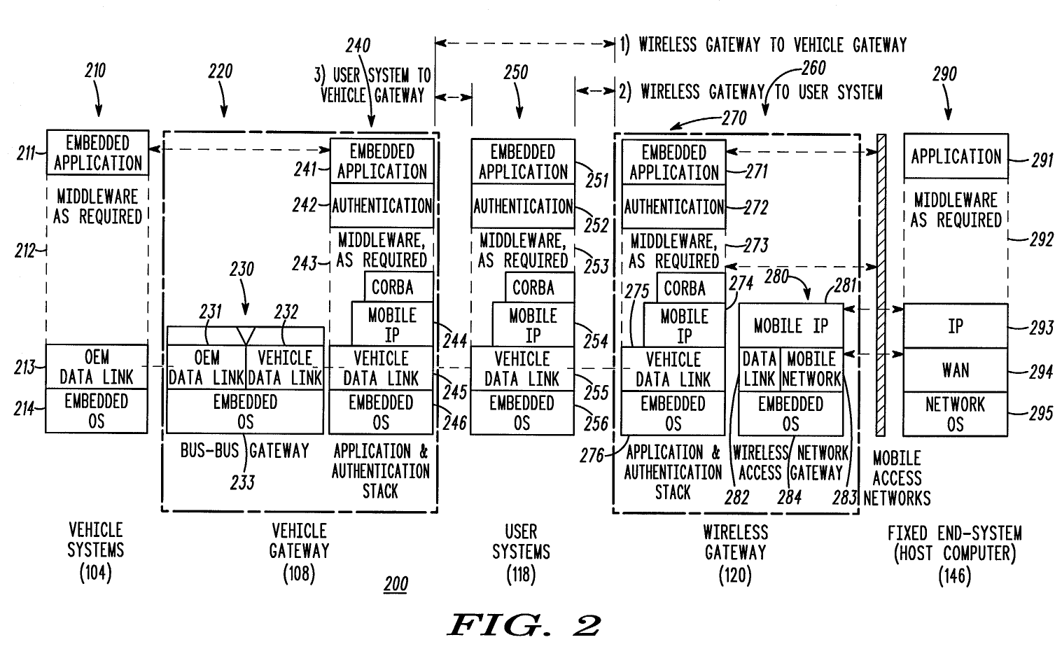

FIG. 2 is a block diagram of a software architecture 200 of telematics communication system 100 in accordance with an embodiment of the present invention. Software architecture 200 includes multiple protocol stacks 210, 220, 230, 240, 250, 260, 270, 280, and 290, all cooperating to implement a distributed application. A first protocol stack 290 of the multiple protocol stacks corresponds to infrastructure 140. At the top of protocol stack 290 is an application layer 291. Application layer 291 executes infrastructure portions of applications running in vehicle 102, which infrastructure portions of the applications are stored in memory 150 and executed by processor 148 of server 146. Below application layer 291 is a middleware layer 292 that services the application layer. Below middleware layer 292, in descending order, are an Internet Protocol (IP) layer 293, a Wide Area Network (WAN) layer 294, and a network operating system 295. IP layer 293 provides transport services to application layer 291 and middleware layer 292 and enables infrastructure 140 to use Internet-based networks to send networking data packets to vehicle system 104 and user system 118 via wireless gateway 120.

A second protocol stack 260 of the multiple protocol stacks corresponds to wireless gateway 120. Wireless gateway 120 routes Internet-derived data packets that are received by the wireless gateway from infrastructure 140 and transmits to infrastructure 140 data packets that are received by the wireless gateway from in-vehicle systems 104 and 118, and from vehicle gateway 108. Protocol stack 260 comprises two protocol stacks, that is, a first protocol stack 280 corresponding to wireless network access gateway 124 and a second protocol stack 270 corresponding to application and authentication stack 122.

A top layer of protocol stack 280, that is, the wireless network access gateway protocol stack, comprises a mobile-IP protocol layer 281 that communicates with IP protocol layer 293 of infrastructure 140 and a mobile-IP protocol layer 274 of protocol stack 270. Below the top layer, on an infrastructure 140 side of protocol stack 280, is a mobile network layer 283. Mobile network layer 283 exchanges data packets with the WAN layer 294 of infrastructure 140 via an embedded operating system 284 of wireless network access gateway 124 and network operating system 295 of infrastructure 140. Below the top layer on a vehicle 102 side of protocol stack 280 is a data link layer 282. Data bus layer 282 provides for an exchange of data with data bus layers of other components 104, 108, 118, and 122 of vehicle 102 via operating system 284 of wireless network access gateway 124, the operating systems of the other components of vehicle 102, and any interconnecting data buses (i.e. buses 106 and/or 116).

The protocol stacks of the application and authentication stacks of each gateway in vehicle 102, that is, of application and authentication stack 122 of wireless gateway 120 and application and authentication stack 110 of vehicle gateway 108, as well as the protocol stack of user system 118, are of similar construction. At the top of each of protocol stacks 240, 250, and 270, respectively corresponding to application and authentication stack 110 of vehicle gateway 108, user system 118, and application and authentication stack 122 of wireless gateway 120, is a respective embedded application layer 241, 251, and 271. Each application layer 241, 251, and 271 comprises a portion of a distributed application running on a processor in the associated component of vehicle 102, which applications are stored in the memory, and executed by the processor, of the component. Each application layer 241, 251, and 271, and the applications running therein, is capable of transparently communicating with the other application layers, and applications running therein, of the components of vehicle 102 and infrastructure 140.

Below each of application layers 241, 251, and 271 is a respective authentication layer 242, 252, and 272 that provides authentication services to their respective vehicle components 108, 118, and 120, and in particular to their respective application layers 241, 251, and 271. Below each authentication layer 242, 252, and 272 is a respective middleware layer 243, 253, and 273 that services the corresponding application layer and authentication layer. Each of middleware layers 243, 253, and 273 may include a CORBA middleware layer. Below each of middleware layers 243, 253, and 273 is a respective mobile-IP layer 244, 254, and 274 that communicates with the mobile-IP layers of the other components of vehicle 102. However, mobile-IP layers 244, 254, and 274 communicate with IP layer 293 of infrastructure 140 via mobile-IP layer 281 of wireless network access gateway 124.

Below each of mobile-IP layers 244, 254, 281 and 274 is a vehicle data link layer 245, 255, and 275, although some middleware layers may access the services of their respective vehicle data bus layer without using the services of the mobile-IP layer. Each of data bus layers 245, 255, and 275 provides for an exchange of data with the data bus layers of the other components of vehicle 102 via a respective embedded operating system 246, 256, and 276 of respective component and the operating systems of the other components of vehicle 102, along with any interconnecting data busses (i.e. 106 and/or 116).

Vehicle gateway 108 comprises two protocol stacks, that is, an application and authentication protocol stack 240 that is described above and a bus-bus gateway protocol stack 230. Vehicle gateway 108 and the two stacks 230, 240 are functionally located between two physical buses: vehicle bus 106 and user bus 116. At the top of bus-bus gateway protocol stack 230, on a user bus 116 side of bus-bus gateway 112, is a vehicle data link layer 232 that communicates with the data link layers of other devices or systems connected to the user bus, such as user system 118 and wireless gateway 120. Data link layer 232 communicates with the data link layers of the other devices systems connected to the user bus via an embedded operating system 233 in vehicle gateway 108 and respective embedded operating systems of the other devices and systems. At the top of the bus-bus gateway protocol stack 230 on a vehicle bus 106 side of the vehicle gateway is an OEM (Original Equipment Manufacturer) data link layer 231. Data link layer 231 communicates with the data link layers of other devices and systems connected to the vehicle bus, such as vehicle system 104, via embedded operating system 233 and embedded operating systems of the other devices and systems connected to the vehicle bus.

At the top of the vehicle system 104 protocol stack, that is, protocol stack 210, is an application layer 211 that comprises an embedded application. Application layer 211, and the applications running therein, is capable of transparently communicating with respective application layers 241, 251, 271 and 291, and applications running therein, of vehicle gateway 108, user system 118, wireless gateway 120, and infrastructure 140. Below application layer 211 is a middleware protocol layer 212 that services the application layer. Below middleware protocol layer 212 is an OEM data link layer 213. Data link layer 213 exchanges data packets with the data link layers of the other components 108, 118, and 120 of vehicle 102 via embedded operating system 214 of vehicle system 104 and the respective embedded operating systems of the other components of the vehicle.

Upon receiving a data packet from infrastructure 140 that is intended for user system 118, wireless gateway 120 conveys the data packet to the user system via user bus 116 using services of Mobile-IP protocol layer 281. This allows middleware protocol layer 292 of software stack 290 of infrastructure 140 to transparently communicate with middleware protocol layer 253 of user system 118. Middleware remote procedure calls (RPC) from infrastructure 140 to user system 118 can be used to authenticate the infrastructure with the user system and to control the user system.

Upon receiving a data packet from infrastructure 140 that is intended for vehicle system 104, wireless gateway 120 conveys the data packet to vehicle gateway 108 via user bus 116, and then from vehicle gateway 108 to vehicle system 104 via vehicle bus 106, using services of Mobile-IP protocol layer 281. The wireless gateway 120 software stack 280 allows middleware protocol layer 292 in infrastructure software stack 290 to transparently communicate with the middleware protocol layer 212 in software stack 210 of vehicle system 104. Middleware remote procedure calls (RPC) from infrastructure 140 to vehicle gateway 108 can be used to authenticate infrastructure 140 with vehicle 102 and to control the vehicle.

Similarly, vehicle gateway 108 can communicate with an application running in application layer 211 of vehicle system 104 by sending data packets over vehicle bus 106, or with an application 251, 271 running on user system 118 or wireless gateway 120, respectively, by sending data packets over user bus 116. Vehicle gateway 108 can then permit only authenticated and authorized application data packets to be sent via vehicle bus 106 and user bus 116 to application software 211, 251, 271 running on any one or more of vehicle system 104, user system 118, and wireless gateway 120, respectively. The authenticated and authorized application data packets can originate, in turn, from any one or more of vehicle system 104, user system 118, and wireless gateway 120.

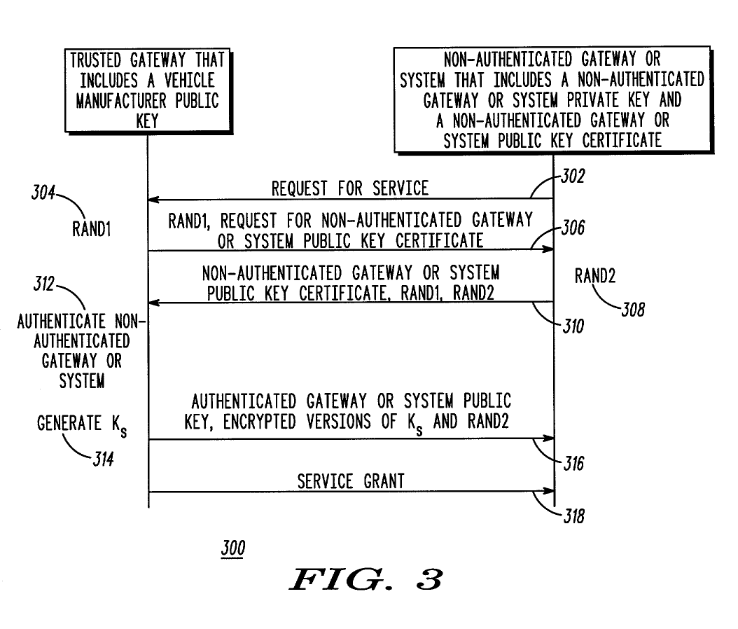

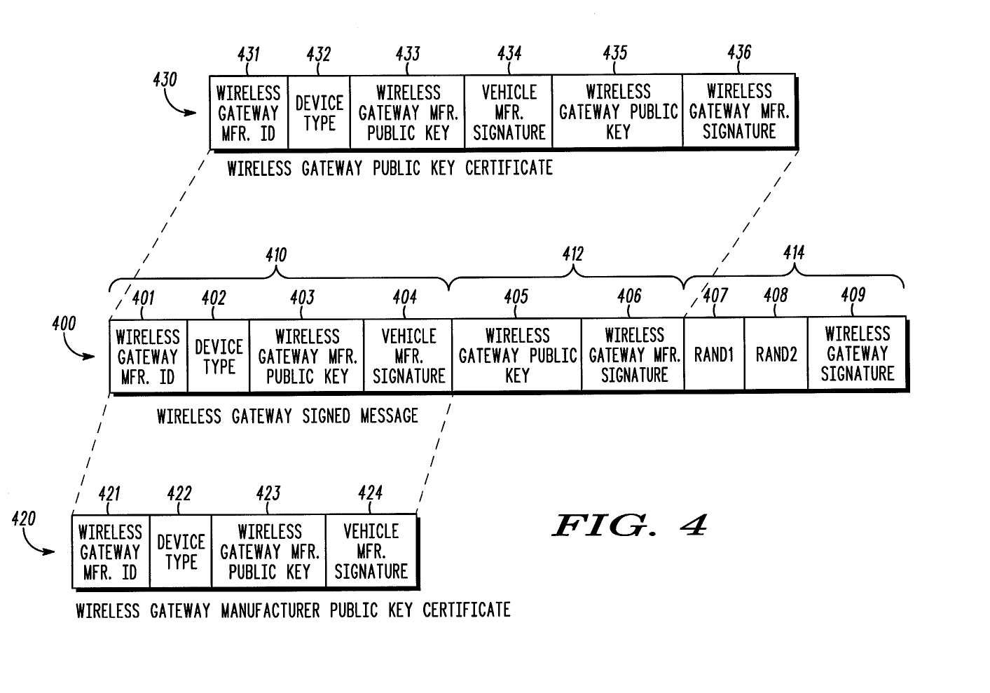

Referring now to FIGS. 3 and 4, a signal generation process is depicted that provides vehicle manufacturers with a capability to select and certify certain suppliers of vehicle system 104 or user system 118 and the supplied systems that may be allowed to operate on vehicle bus 106 and user bus 116. FIG. 3 is a signal flow diagram 300 of the signature generation and verification process in accordance with an embodiment of the present invention. FIG. 4 is a block diagram of a wireless gateway signed message 400, a wireless gateway manufacturer public key certificate 420, and a wireless gateway public key certificate 430 that are used, along with attendant public and private keys and precursor data fields, in the signal generation process depicted in FIG. 3 in accordance with an embodiment of the present invention. Wireless Gateway Public Key Certificate 430 shows a further decomposition of wireless gateway cryptographic public key certificate 128 that was previously described in conjunction with FIG. 1, above.

The manufacturer of vehicle 102 issues a wireless gateway manufacturer private key certificate 420 that corresponds to the wireless gateway manufacturer private key to only approved manufacturers of wireless gateway 120. This certificate is signed using the vehicle manufacturer private key and is issued to approved manufacturers of wireless gateway 120. By use of the vehicle manufacturers private key, the vehicle manufacturer is able to make sure that only the wireless gateways of approved and certified wireless gateway manufacturers are allowed to have their gateways operate and communicate with vehicle gateway 108. Also, the vehicle manufacturer may issue the certificates only to approved manufacturers of user system 118. Only user systems of approved and certified user system manufacturers are then allowed to operate and communicate with vehicle gateway 108. In addition, unique data fields within certificate 420 allow the vehicle manufacturer to specify capabilities such as a level of service to be granted and an establishment of session keys that provide the security and confidentiality to overcome various cryptographic attacks as are well known in the art.

Referring now to FIG. 4, wireless gateway signed message 400 includes multiple data fields 401-409. A first portion 410 of message 400 includes data fields 401-404, which data fields include a wireless gateway manufacturer identifier (Mfr. ID) data field 401, a device type data field 402, a wireless gateway manufacturer public key data field 403 (optional), and a vehicle manufacturer signature data field 404. A second portion 412 of message 400 includes data fields 405 and 406, which data fields include a wireless gateway public key 405 and a wireless gateway manufacturer signature 406. A third portion 414 of message 400 includes data fields 407-409, which data fields include a first random number data field 407, a second random number data field 408, and a wireless gateway signature data field 409.

Data fields 401-404 of first portion 410 of message 400 are populated with data from wireless gateway manufacturer public key certificate 420, which certificate's data is generated by the manufacturer of vehicle 102. Wireless gateway manufacturer public key certificate 420 is issued by the vehicle manufacturer and includes data fields 421-424, which data fields include a wireless gateway manufacturer identifier (Mfr. ID) data field 421, a device type data field 422, and a vehicle manufacturer signature data field 424. Certificate 420 may further include a wireless gateway manufacturer public key data field 423, although in another embodiment of the present invention data field 423 is not included in certificate 420. Data fields 421-424 are unique to the manufacturer of wireless gateway 120. Wireless gateway manufacturer public key certificate 420 is created in a secure and controlled environment as is well known in the public key cryptography art.

Data fields 401-404 of first portion 410 of message 400 correspond to data fields 421-424 of certificate 420. The data included in each of data fields 401-404 is a copy of the data included in data fields 421-424 of certificate 420 and is propagated or made known to the manufacturers of each of vehicle gateway 108 and wireless gateway 120 by the manufacturer of vehicle 102, for example by conveying certificate 420 to the manufacturers of gateways 108 and 120. Vehicle manufacturer signature data field 404 is signed as described below using a vehicle manufacturer's private key.

In one embodiment of the present invention, wireless gateway 120 stores data fields 421-424 and the data included in wireless gateway manufacturer public key certificate 420. Vehicle gateway 108 stores vehicle manufacturer public key 114. As is described in greater detail below, vehicle gateway 108 uses the vehicle manufacturer public key 114 to establish the authenticity of vehicle manufacturer-signed certificate 420.

A digital signature, such as vehicle manufacturer signature 424, over a message ‘M’, such as vehicle manufacturer-signed certificate 420, typically includes multiple bits that are dependent on the message content and on secret information, that is, a private key, known only to the signer, that is, the vehicle manufacturer. The digital signature is usually verifiable without requiring access to the signer's secret information (the private key). The signature verification is accomplished using the signer's public key. Those who are of ordinary skill in the art realize that there exist many digital signature algorithms and schemes, such as the Digital Signature Algorithm (DSA) that was developed by the National Institute of Standards & Technology NIST, RSA signature, ELGAMAL signature, Elliptic Curve Digital Signature Algorithm (ECDSA), etc., that may be used herein for the digital signature without departing from the spirit and scope of the present invention.

For example, in the case of an RSA signature, assume that the vehicle manufacturer has a public key ‘e’ and a private key ‘d’, wherein each of ‘e’ and ‘d’ is a value that may be represented by a bit string and wherein

ed=1 (mod φ), φ=(p−1)(q−1), n=pq, and 1<e<φ,

such that the greatest common denominator of (e, φ)=1. The vehicle manufacturer desires to sign a given message or a certificate ‘M’, such as wireless gateway manufacturer's public key certificate 420. A message digest ‘m’, typically consisting of 160 bits, is generated from a variable length message using a Secure Hash Algorithm (SHA−1), wherein m=SHA−1 (M). The signature ‘s’ is then generated such that:

s=m^{d} mod n.

To verify the signature ‘s’, a verifier, that is, vehicle gateway 108, uses the vehicle manufacturer public key ‘e’ to recover ‘m′’ wherein

m′=s^{e} mod n.

The verifier also generates ‘m’ and compares ‘m’ to ‘m′’. If m=m′ the signature is accepted, and if not, the signature is rejected.

FIG. 4 further depicts a wireless gateway public key certificate 430. Wireless gateway public key certificate 430 includes multiple data fields 431-436, which data fields include a wireless gateway manufacturer identifier (Mfr. ID) data field 431, a device type data field 432, a wireless gateway manufacturer public key data field 433 (optional), a vehicle manufacturer signature data field 434, a wireless gateway public key 435 and a wireless gateway manufacturer signature 436. Data fields 431-436 correspond to data fields 401-406 of the first and second portions 410, 412 of wireless gateway signed message 400. Data fields 431-434 further respectively correspond to, and incorporate the data of, data fields 421-424 of wireless gateway manufacturer public key certificate 420, and every wireless gateway, such as wireless gateway 120, manufactured by a particular wireless gateway manufacturer has the same data in data fields 431-434. However, each such wireless gateway manufactured by the wireless gateway manufacturer generates a unique wireless gateway public key 435. The wireless gateway manufacturer signs certificate 430 using the wireless gateway manufacturer's private key 126, which signature is stored in data field 436. The process of signing certificate 430 is executed once. It should be noted that there is an association between the wireless gateway public key data field 435 and the wireless gateway private key 126; both are generated within a secure and controlled environment.

Referring now to FIGS. 3 and 4, a process is provided for authentication of, and a grant of service to, a non-authenticated gateway or system in vehicle 102 by a trusted gateway in the vehicle in accordance with an embodiment of the present invention. In one embodiment of the present invention, a trusted vehicle gateway, such as vehicle gateway 108, authenticates and grants services to a non-authenticated wireless gateway 120 in order that the wireless gateway may have access to vehicle bus 106. Wireless gateway signed message 400 is updated during the course of service requests initiated by wireless gateway 120. In other embodiments of the present invention, a trusted vehicle gateway 108 or wireless gateway 120 may authenticate and grant service to a non-authenticated vehicle system 104 or user system 118.

The authentication process begins when the non-authenticated gateway or system, for example wireless gateway 120 or user system 118, conveys (302) a request for service to a trusted gateway, for example vehicle gateway 108. Although the process is described below with reference to a non-authenticated wireless gateway 120 and a trusted vehicle gateway 108, the authentication and grant of service process described in FIG. 3 also applies, as noted above, to an authentication of, and a grant of service to, a non-authenticated vehicle system 104 or user system 118 by a trusted vehicle gateway 108 or a trusted wireless gateway 120.

In response to receiving the request for service, vehicle gateway 108 generates (304) a first random number, RAND1, and conveys (306), to wireless gateway 120, the first random number along with a request that the wireless gateway send the wireless gateway public key certificate 430 to the vehicle gateway. The request conveyed to wireless gateway 120 includes the first random number. In response to receiving the request for the public key certificate, wireless gateway 120 generates (308) a second random number, RAND2, and conveys (310) a wireless gateway signed message 400 to vehicle gateway 108 that includes wireless gateway public key certificate 430, RAND1, and RAND2. Wireless gateway 120 inserts the first random number, RAND1, into data field 407 of message 400 and inserts the second random number, RAND2, into data field 408 of message 400. The wireless gateway signed message 400 conveyed by wireless gateway 120 is also signed by wireless gateway 120, using the wireless gateway's private key 126, which signature is inserted into data field 409 of message 400 and is based on the data stored in each of data fields 401-408.

Upon receiving the signed message 400 conveyed by wireless gateway 120, vehicle gateway 108 authenticates (312) the wireless gateway. Vehicle gateway 108 authenticates wireless gateway 120 by verifying one or more of the vehicle manufacturer signature stored in data field 404, the wireless gateway manufacturer signature stored in data field 406, and the wireless gateway signature stored in data field 409. Vehicle gateway 108 verifies the vehicle manufacturer signature stored in data field 404 using the vehicle manufacturer public key 114, verifies the wireless gateway manufacturer signature stored in data field 406 using the wireless gateway manufacturer public key stored in data field 403, and verifies the wireless gateway signature stored in data field 409 using the wireless gateway public key stored in data field 405. In another embodiment of the present invention, instead of using wireless gateway manufacturer public key stored in data field 403, the vehicle manufacturer ID stored in data field 402 could be used to retrieve the wireless gateway manufacturer public key from a table stored in vehicle gateway 108, which table includes wireless gateway manufacturers' public keys.

Wireless gateway manufacturer public key certificate 420 has been signed by the vehicle manufacturer identifying the wireless gateway manufacturer in data field 421 and identifying the level of service granted to the wireless gateway manufacturer in the device type data field 422. If the request for service conveyed by wireless gateway 120 in step 302 is a permitted service according to device type data field 404, vehicle gateway 108 generates (314) a session key ‘Kₛ’ and uses the wireless gateway public key stored in data field 405 to encrypt the session key and the second random number, RAND2. Vehicle gateway 108 then conveys (316) the encrypted session key and second random number to wireless gateway 120.

In another embodiment of the present invention, vehicle gateway 108 may also convey (318) a service grant to wireless gateway 120, depending upon the specific type of service requested in step 302. For example, a service request such as “Request to open a door lock” results in a service grant such as granting the request by opening the door lock. In this case, a service request (“open door lock”) coming from the infrastructure 140 to the wireless gateway 120, results in a service grant. The resulting application message flows from the wireless gateway 120, thru the vehicle gateway 108 to the door lock subsystem (a specialization of vehicle system 104) and opens the door. Wireless gateway 120 then uses the wireless gateway private key 126 to decrypt the session key ‘Kₛ’ and RAND2. RAND1 and RAND2 are employed to stop play-back, or encryption, attacks. The session key Kₛ is then used by each of vehicle gateway 108 and wireless gateway 120 to encrypt the bidirectional communications between them for the duration of the session, thereby providing for secure communications.

By providing a trusted entity in vehicle 102, that is, vehicle gateway 108, that is capable of authenticating, and granting service to, a non-authenticated gateway or system in the vehicle, the manufacturer of vehicle 102 is able to provide a secure system by which systems and gateways may access vehicle bus 106 or user bus 116. In this way, the vehicle manufacturer is able to assure that the devices and gateways subsequently added to the vehicle are certified devices and gateways that are manufactured by certified suppliers, and is further able to protect against unauthorized, third party access to the vehicle systems. Furthermore, by providing a trusted gateway in vehicle 102 that is capable of authenticating other gateways and systems, the suppliers of gateways and systems to the manufacturer of vehicle 102 and to the ‘aftermarket,’ or subsequently-added, part market are able to manufacture low cost components since the suppliers can manufacturer ‘thin clients’ that need not, in themselves, support an authentication mechanism.

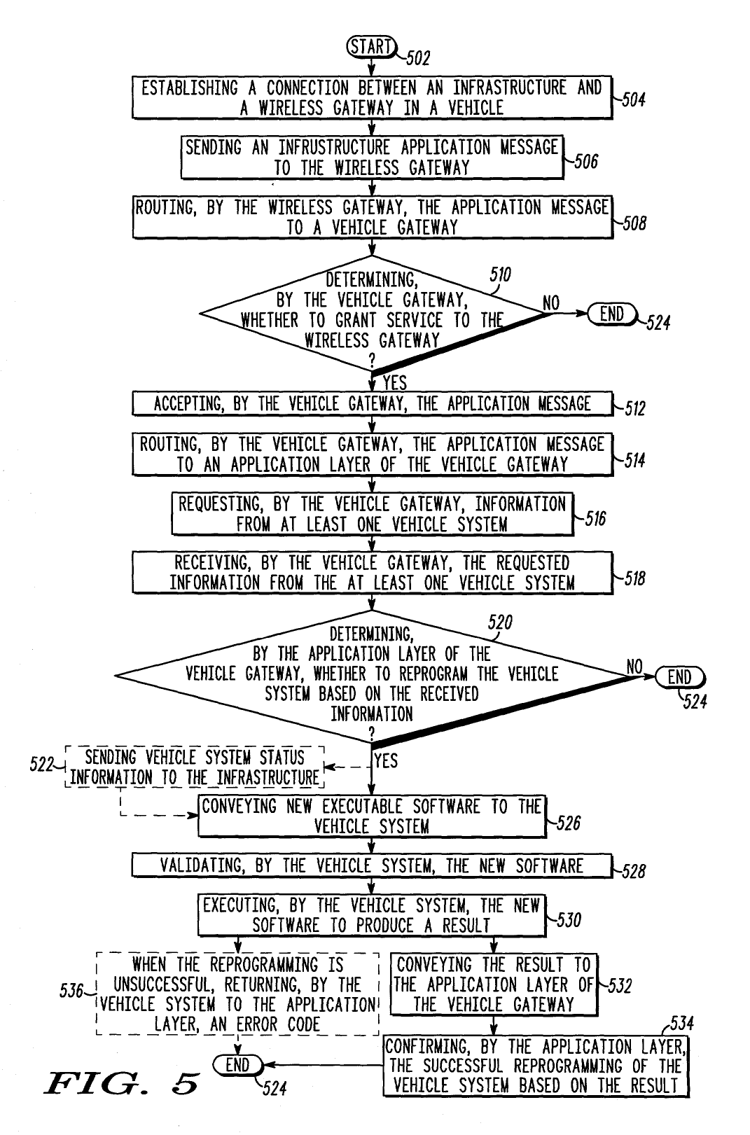

FIG. 5 is a logic flow diagram 500 of steps by which a remote person or entity, such as a manufacturer of vehicle 102 that controls or operates server 146, can wirelessly reprogram a destination system contained in vehicle 102, such as vehicle system 104 or user system 118, in accordance with an embodiment of the present invention. The remote person or entity is able to wirelessly communicate with vehicle 102 via infrastructure 140, and in particular via server 146, network 144, base station 142 and RF communication link 132. Although logic flow diagram 500 is described below with respect to a reprogramming of vehicle system 104, those who are of ordinary skill in the art realize that user system 118 may be similarly reprogrammed without departing from the spirit and scope of the present invention. In that regard, the references below to vehicle system 104 are merely meant to illustrate the principles of the present invention and are not intended to limit the present invention in any way.

Logic flow diagram 500 begins (502) when server 146, via infrastructure 140, establishes (504) a wireless connection with the wireless gateway 120 of vehicle 102. The wireless connection is a routable connection using a well-known address protocol, such as Internet Protocol (IP) addresses, for wireless communications between two devices, that is, between server 146 of infrastructure 140 and wireless gateway 120. When the connection is established, an application running in application layer 291 of infrastructure 140 sends (506) an application message that includes a service request and executable software to wireless gateway 120. Wireless gateway 120 then routes (508) the message to vehicle gateway 108.

Upon receiving the message, vehicle gateway 108 either grants or denies (510) the service request based on whether wireless gateway 120 is an authenticated device. When wireless gateway 120 is an authenticated device, vehicle gateway 108 grants the service request made by the application running in application layer 291. When wireless gateway 120 is not an authenticated device, the logic flow ends (524). Upon grant of the service request, vehicle gateway 108 accepts (512) the message and routes (514) the message to embedded application layer 241 of vehicle gateway 108. In addition, vehicle gateway 108 then requests (516) status information from one or more vehicle systems 104. The requested status information may include, but not be limited to: the current mileage of the vehicle, a vehicle identification number, an engine diagnostic code, a version number of the current executing software in vehicle system 104, and a checksum computed over the program code, all of which are well-known elements in the art. In response to the request from vehicle gateway 108, vehicle system 104 conveys to vehicle gateway 108, and the vehicle gateway receives (518) from the vehicle system, the requested information.

Upon receiving the requested information from vehicle system 104, an application running in application layer 241 of vehicle gateway 108 determines (520), based on the message received from the application running in application layer 291 and the information received from vehicle system 104, whether to reprogram vehicle system 104. In making a determination as to whether to reprogram vehicle system 104, the application running in application layer 241 may consider factors such as whether the current version of the vehicle system software version embodied in vehicle system 104 is the same version, or a prior version, as compared to the version of the software information conveyed by the application running in application layer 291 of infrastructure 140, or whether the current vehicle environment is appropriate for reprogramming of vehicle system 104. For example, in determining whether the current vehicle environment is appropriate for reprogramming, the application running in application layer 241 may consider whether the vehicle is moving, whether the engine is running, and other relevant parameters that may be of interest in safely reprogramming vehicle system 104. Vehicle gateway 108 can obtain the information considered by the application running in application layer 241 in determining whether to reprogram vehicle system 104 by retrieving status information from the system and from any other vehicle systems, as appropriate. In addition, vehicle gateway 108 may send (522) the status information to the application running in application layer 291 of infrastructure 140 via user bus 116 and wireless gateway 120.

When vehicle gateway 108 determines (520) not to reprogram vehicle system 104, the logic flow ends (524). When vehicle gateway 108 determines (520) to reprogram vehicle system 104, vehicle gateway 108 conveys (526) new, executable software received from the application running in application layer 291 of infrastructure 140 to vehicle system 104. When the current vehicle environment is appropriate for reprogramming of vehicle system 104, the new software is validated (528) and executed (530) by vehicle system 104 to produce a result. The vehicle system 104 then conveys (532) the result to the application running in application layer 241 of vehicle gateway 108, and the application running in application layer 241 confirms (534) that the vehicle system has been successfully reprogrammed based on the result. The logic flow then ends (524). In another embodiment of the present invention, the result may be an error code and vehicle system 104 may report (536) an unsuccessful reprogramming by returning the error code to the application running in application layer 241 of vehicle gateway 108.

In an embodiment of the present invention wherein the destination system is vehicle system 104, the destination system may include a motive power source (e.g., an engine) and the new software may be arranged to modify or improve the operation of the motive power source. In other embodiments of the present invention wherein the destination system is vehicle system 104, the destination system may include an automotive transmission system and the new software may be arranged to modify or improve the operation of the transmission system, or the destination system may include a braking system and the new software may be arranged to modify or improve the operation of the brakes.

In another embodiment of the present invention wherein the destination system is user system 118, the user system may include an entertainment system and the new software may be arranged to modify or improve the operation of the entertainment system. In other embodiments of the present invention wherein the destination system is user system 118, the user system may include a personal computer and the new software may be arranged to modify or improve the operation of the personal computer, the user system may include a navigation system and the new software may be arranged to modify or improve the operation of the navigation system, or the user system may include a user interface device, such as a cellular telephone, pager, two-way radio, or interface of a personal computer, and the new software may be arranged to modify or improve the operation of the user interface.

In still other embodiments of the present invention, the new software may include any one or more of executable code, one or more data files, and one or more requests or commands. Those who are of ordinary skill in the art realize that the steps depicted by logic flow diagram 500 may be used for transferring yet other new programs to yet other vehicle systems without departing from the spirit and scope of the present invention.

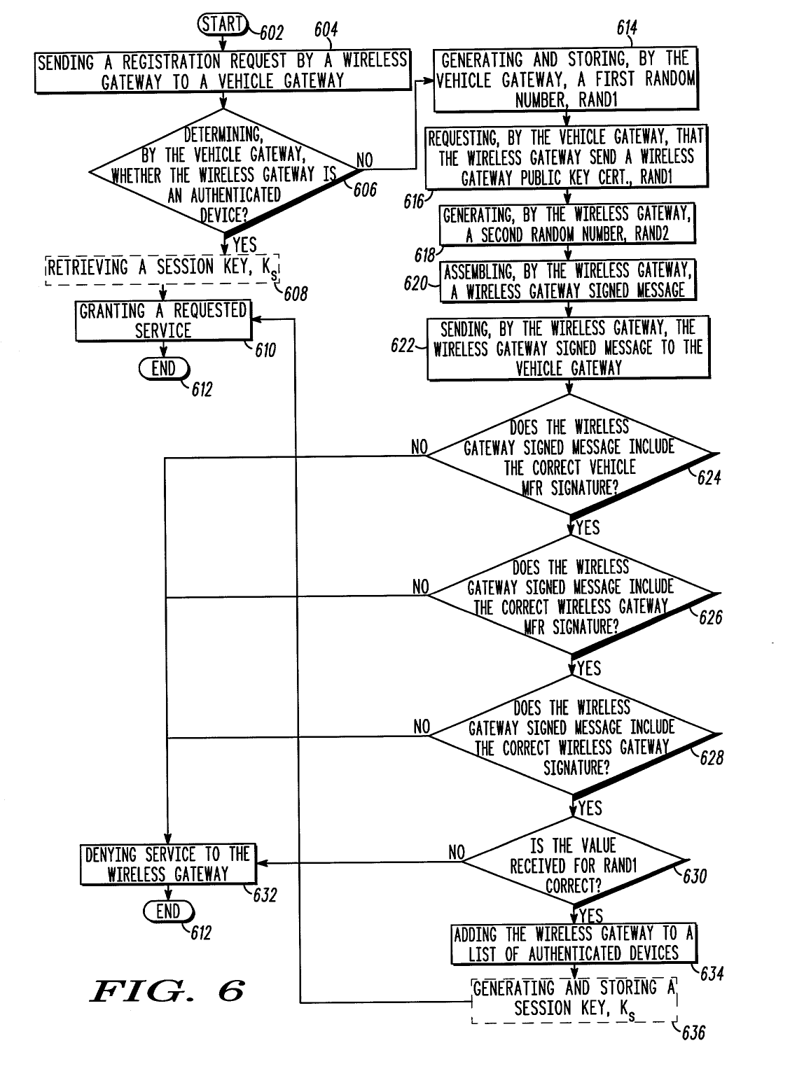

FIG. 6 is a logic flow diagram 600 of the steps performed by vehicle gateway 108 in granting or denying a service request by wireless gateway 120 (step 510 of logic flow diagram 500) in a secure and authenticated manner in accordance with an embodiment of the present invention. Logic flow diagram 600 begins (602) when vehicle gateway 108 receives (604) a service request from wireless gateway 120. In response to receiving the service request, vehicle gateway 108 determines (606) whether wireless gateway 120 is an authenticated device by reference to register 109 of vehicle gateway 108. When vehicle gateway 108 determines (606) that wireless gateway 120 is an authenticated device, the vehicle gateway grants (610) the requested service and the logic flow ends (612). The vehicle gateway may also retrieve (608) a session key, Kₛ, that is conveyed with the grant of service.

When vehicle gateway 108 determines (606) that wireless gateway 120 is not an authenticated device, the vehicle gateway generates and stores (614) a first random number, RAND1, and sends (616) RAND1 to the wireless gateway along with a request that the wireless gateway send a wireless gateway public key certificate 430. In response to receiving the request and RAND1, wireless gateway 120 generates (618) a second random number, RAND2, assembles (620) a wireless gateway signed message 400, and sends (622) the message 400 to vehicle gateway 108. The wireless gateway signed message 400 conveyed by wireless gateway 120 to vehicle gateway 108 includes the wireless gateway public key certificate 430, RAND1, RAND2, and a wireless gateway signature that is generated by the wireless gateway using wireless gateway private key 126.

Upon receiving the signed message 400 from wireless gateway 120, vehicle gateway 108 authenticates (624, 626, 628, 630) the wireless gateway. Preferably, vehicle gateway 108 authenticates wireless gateway 120 by verifying (624) the vehicle manufacturer signature stored in data field 404 of the received message 400, verifying (626) the wireless gateway manufacturer signature stored in data field 406 of the received message 400, verifying (628) the wireless gateway signature stored in data field 409 of the received message 400, and verifying (630) that the value received for RAND1 is the same as the stored RAND1 value. In other embodiments of the present invention, vehicle gateway 108 may authenticate wireless gateway 120 by performing any one or more of steps 624, 626, 628, and 630.

Vehicle gateway 108 verifies (624) the vehicle manufacturer signature stored in data field 404 using the vehicle manufacturer public key 114. Vehicle gateway 108 verifies (626) the wireless gateway manufacturer signature stored in data field 406 using the wireless gateway manufacturer public key stored in data field 403 of the received message 400. Vehicle gateway 108 verifies (628) the wireless gateway signature stored in data field 409 using the wireless gateway public key stored in data field 405 of the received message 400. In another embodiment of the present invention, instead of using wireless gateway manufacturer public key stored in data field 403, the vehicle manufacturer ID stored in data field 402 could be used to retrieve the wireless gateway manufacturer public key from a table stored in vehicle gateway 108, which table includes wireless gateway manufacturers' public keys.

When vehicle gateway 108 is unable to verify any one of the vehicle manufacturer signature, the wireless gateway manufacturer signature, the wireless gateway signature, and the value received for RAND1, the vehicle gateway denies (632) service to wireless gateway 102 and the logic flow ends (612). When vehicle gateway 108 successfully verifies each of the vehicle manufacturer signature, the wireless gateway manufacturer signature, the wireless gateway signature, and the value received for RAND1, the vehicle gateway adds (634) wireless gateway 120 to the list of authenticated vehicle systems and devices stored in register 109 and grants (610) service to the wireless gateway, and the logic flow ends (612). Vehicle gateway 108 may also generate and store (636) a session key, Kₛ, which session key is securely conveyed to wireless gateway 120 with the grant of service.

Referring now to FIG. 5, instead of sending the executable software to vehicle gateway 108 along with the service request (steps 506, 508), in another embodiment of the present invention the application running in application layer 291 of infrastructure 140 may send the executable software to the vehicle gateway after wireless gateway 120 has been granted service by the vehicle gateway and after the application running in application layer 291 has received the status information for vehicle system 104 (step 522). By waiting to send the executable software until after wireless gateway 120 has been authenticated and granted service, capacity of system 100 may be more efficiently utilized since software will not be sent to vehicles with invalid systems.

By providing a trusted entity, that is, vehicle gateway 108, that can authenticate and grant service to a non-authenticated gateway or system in vehicle 102, a gateway or system may be subsequently added to and removed from the vehicle, such a cellular telephone that may be used as a wireless gateway by the vehicle's systems, without the need to bring the vehicle or the non-authenticated gateway or system to a service center. The use of the trusted entity also allows the manufacturer of vehicle 102 to assure that subsequently added components are manufactured by certified suppliers and operate accordance with the vehicle manufacturer's specifications. The use of a trusted entity in vehicle 102 for authentication and service grants also permits a broad range of components to be subsequently added to a manufactured vehicle, since the vehicle is itself capable of authenticating the added components, and protects against unauthorized, third party access to the vehicle systems.

In addition, the trusted entity provides a means by which a remote person or entity, such as a manufacturer of vehicle 102 that controls or operates network server 146, can wirelessly reprogram a destination system of vehicle 102 in a secure manner. This saves vehicle and vehicle gateway and system manufacturers the time and expense of notifying the owners to bring in their vehicles for software updates, and saves vehicle and owners the time and expense of visiting a service center. Furthermore, the trusted entity allows the vehicle manufacturer to remotely communicate with, and reprogram, in a secure manner, gateways and systems in a mass, single effort rather than on a vehicle-by-vehicle basis.

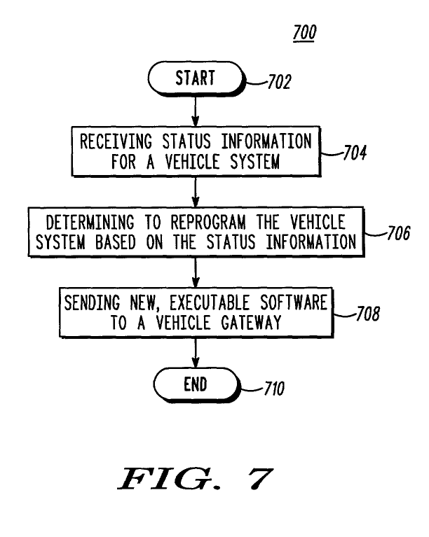

FIG. 7 is a logic flow diagram 700 of steps executed by the application running in application layer 291 of infrastructure 140 in sending the executable software to the vehicle gateway 108 after the vehicle gateway has granted service to wireless gateway 120. Logic flow diagram 700 begins (702) when the application running in application layer 291 of infrastructure 140 receives (704) the status information. Upon receiving (704) the status information, the application running in application layer 291 determines (706) whether to reprogram vehicle system 104 based on the received status information. In another embodiment of the present invention, the step of sending (522) status information to the application running in application layer 291 may include steps of encrypting, by vehicle gateway 108, the status information to produce encrypted status information and then sending the encrypted status information to the application running in application layer 291. When the status information has been encrypted, the step of determining (706) whether to reprogram the vehicle system 104 includes steps of decrypting, by the application running in application layer 291, the encrypted status information to produce decrypted status information and determining whether to reprogram the vehicle system based on the decrypted status information.

The application running in application layer 291 of infrastructure 140 then sends (708) the new, executable software to vehicle gateway 108, and the logic flow ends (710). As described in step 526 of logic flow diagram 500, vehicle gateway 108 then conveys the new, executable software to vehicle system 104. In another embodiment of the present invention, the step of sending (708) the new software may include steps of encrypting, by the application running in application layer 291, the new software to produce encrypted software and then sending the encrypted software to vehicle gateway 108. When the new software has been encrypted, the step of validating the new software, described above in step 528 of logic flow diagram 500, includes steps of decrypting, by vehicle gateway 108 or vehicle system 104, the encrypted new software to produce a decrypted new software and validating, by vehicle system 104, the decrypted new software.

In sum, a telematics communication system 100 that includes an infrastructure 140 and a vehicle 102 provides for in-vehicle authentication and service grants by an in-vehicle trusted entity. The trusted entity, preferably a vehicle gateway 108 coupled to each of a vehicle bus 106 and a user bus 116 and thereby able to service gateways, devices, and systems coupled to either bus, is capable of authenticating a wireless gateway 120 and in-vehicle systems 104, 118 and of processing service requests and authenticated service grants for the authenticated wireless gateway and the authenticated in-vehicle system. By providing a trusted entity in vehicle 102 for authentication of, and for processing service requests by, in-vehicle gateways and systems, a manufacturer of vehicle 102 is able to assure that the devices and gateways subsequently added to the vehicle are certified devices and gateways that are manufactured by certified suppliers, and is further able to protect against unauthorized, third party access to the vehicle systems. In addition, the trusted entity is capable of authenticating other gateways and systems, allowing gateway and system manufacturers to manufacture low cost components that need not, in themselves, support an authentication mechanism. Furthermore, the trusted entity allows a remote person or entity, such as a manufacturer of vehicle 102 that controls or operates network server 146, to remotely communicate with, and wirelessly reprogram, gateways and systems in the vehicle in a secure manner.

While the present invention has been particularly shown and described with reference to particular embodiments thereof, it will be understood by those skilled in the art that various changes may be made and equivalents substituted for elements thereof without departing from the spirit and scope of the invention. In addition, many modifications may be made to adapt a particular situation or material to the teachings of the invention without departing from the essential scope thereof. Therefore, it is intended that the invention not be limited to the particular embodiments disclosed herein, but that the invention will include all embodiments falling within the scope of the appended claims.

What is claimed is:

1. A method for authentication of an entity in a motive vehicle by a trusted gateway residing in the vehicle, wherein the entity is either one of a gateway or a vehicle system, the method comprising steps of:
receiving a request for service for the entity;
determining whether the entity is an authenticated entity; and
when the entity is not an authenticated entity, authenticating the entity to produce an authenticated entity.

2. The method of claim 1, wherein the step of determining whether the entity is an authenticated entity comprises a step of determining whether the entity is an authenticated entity by reference to a list of authenticated entities.

3. The method of claim 1, further comprising a step of adding the entity to a list of authenticated entities when the entity is authenticated.

4. The method of claim 1, further comprising a step of, when the entity is an authenticated entity, granting the request for service.

5. The method of claim 1, wherein the step of authenticating the entity comprises steps of:
requesting, from the entity, a certificate comprising a vehicle manufacturer signature;
receiving a message comprising the requested certificate; and
determining whether the entity is an authenticated entity based on the received message.

6. The method of claim 5, wherein the message comprising the requested certificate further comprises an entity signature and an entity manufacturer signature.

7. The method of claim 6, wherein the step of authenticating the entity further comprises steps of:
verifying at least one of the vehicle manufacturer signature, the entity signature, and the entity manufacturer signature; and
wherein the step of determining whether the entity is an authenticated entity comprises a step of determining whether the entity is an authenticated entity based on the verification of at least one of the vehicle manufacturer signature, the entity signature, and the entity manufacturer signature.

8. The method of claim 1, wherein the step of authenticating the entity comprises steps of:
generating a first random number;
conveying, to the entity, the first random number and a request that the entity send a certificate comprising a vehicle manufacturer signature;
receiving a message comprising the certificate having a vehicle manufacturer signature and further comprising an entity signature, an entity manufacturer signature, the first random number, and a second random number; and
wherein the step of determining whether the entity is an authenticated entity comprises a step of determining whether the entity is an authenticated entity based on the verification of at least one of the vehicle manufacturer signature, the entity signature, and the entity manufacturer signature.

9. The method of claim 1, further comprising steps of:
when the entity is an authenticated entity, generating a session key; and
securely conveying the session key to the authenticated entity.

10. The method of claim 1, further comprising a step of determining whether to reprogram the entity when the second entity is an authenticated entity.

11. The method of claim 10, wherein the step of determining whether to reprogram the entity comprises steps of:
retrieving vehicle system status information from the entity; and
determining whether to reprogram the entity based on the retrieved vehicle system status information.

12. The method of claim 10, further comprising steps of
in response to a determination to reprogram the entity, reprogramming the entity with new software;
when the entity is reprogrammed, executing the new software by the entity to produce a result;
conveying the result to the trusted entity; and
determining whether the reprogramming is successful based on the result.

13. The method of claim 12, wherein the entity is a vehicle system that comprises vehicle system status information and wherein the method further comprises steps of:
retrieving vehicle system status information from the entity; and
transmitting the retrieved vehicle system status information.

14. The method of claim 13, further comprising a step of receiving new software in response to the transmission of vehicle system status information.

15. The method of claim 13, wherein the vehicle system status information comprises at least one of a current date, a current time, a current location of the vehicle, a current mileage of the vehicle, a vehicle identification number, and an engine diagnostic code.

16. The method of claim 1, further comprising steps of:
when the entity is determined to be an authenticated entity, generating a session key; and
securely conveying the session key to the authenticated entity.

17. An apparatus for authenticating an entity in a vehicle, the apparatus comprising:
a first, trusted entity residing in the vehicle that receives a service request from a second entity residing in the vehicle, determines whether the second entity is an authenticated entity in response to the request, and when the second entity is not an authenticated entity, authenticates the second entity to produce an authenticated entity.

18. The apparatus of claim 17, wherein the trusted entity stores a list of authenticated entities and determines whether the second entity is an authenticated entity by reference to the list.

19. The apparatus of claim 17, wherein the trusted entity stores a list of authenticated entities and adds the second entity to the list when the trusted entity authenticates the second entity.

20. The apparatus of claim 17, wherein the trusted entity comprises a vehicle manufacturer public key, wherein the trusted entity requests, from the second entity, a certificate comprising a vehicle manufacturer signature and, in response to the request for the certificate, receives a message comprising the requested certificate, and wherein the trusted entity authenticates the second entity based on the received message.

21. The apparatus of claim 20, wherein the message comprising a vehicle manufacturer signature further comprises a second entity manufacturer signature and a second entity signature.

22. The method of claim 21, wherein the trusted entity authenticates the second entity by verifying at least one of the vehicle manufacturer signature, the second entity manufacturer signature, and the second entity signature.

23. The apparatus of claim 17, wherein the trusted entity further generates a first random number, conveys, to the second entity, the first random number and a request that the second entity send a certificate comprising a vehicle manufacturer signature, receives, in response to conveying the request for the certificate, a message comprising the first random number, a second random number, and the certificate having a vehicle manufacturer signature, and authenticates the second entity based on the received message.

24. The apparatus of claim 17, wherein the trusted entity generates a session key when the second entity is an authenticated entity and securely conveys the session key to the second entity.

25. The apparatus of claim 17, wherein the trusted entity conveys a service grant to the second entity when the second entity is an authenticated entity.

26. The apparatus of claim 17, wherein the second entity is a vehicle system that comprises vehicle system information and wherein the trusted entity retrieves vehicle system status information from the vehicle system and determines whether to reprogram the entity based on the vehicle system information.

27. In a vehicle in wireless communication with an infrastructure, an apparatus comprising:
a first, trusted entity residing in the vehicle;
a second entity residing in the vehicle and in communication with the trusted entity; and
wherein the trusted entity receives a service request, determines whether the second entity is an authenticated entity in response to the service request, and, when the second entity is not an authenticated entity, authenticates the second entity to produce an authenticated entity.

28. The apparatus of claim 27, wherein the trusted entity receives the service request from the infrastructure.

29. The apparatus of claim 27, wherein the second entity conveys the service request to the trusted entity.

30. The apparatus of claim 27, wherein the trusted entity stores a list of authenticated entities and determines whether the second entity is an authenticated entity by reference to a list of authenticated entities.

31. The apparatus of claim 27, wherein the trusted entity stores a list of authenticated entities and adds the second entity to a list of authenticated entities when the trusted entity authenticates the second entity.

32. The apparatus of claim 27, wherein the trusted entity comprises a vehicle manufacturer public key, wherein the trusted entity conveys a request to the second entity for a message comprising a vehicle manufacturer signature, wherein, in response to the request, the second entity conveys a message to the trusted entity comprising the vehicle manufacturer signature, and wherein the trusted entity authenticates the second entity based on the message.

33. The apparatus of claim 27, wherein the trusted entity comprises a vehicle manufacturer public key, wherein the second entity comprises a second entity private key, a certificate having a vehicle manufacturer signature, and a second entity manufacturer signature, wherein the trusted entity conveys a request to the second entity for a message comprising the vehicle manufacturer signature, wherein, in response to the request, the second entity conveys a message to the trusted entity comprising the vehicle manufacturer signature, the second entity manufacturer signature, and a second entity signature, and wherein the trusted entity authenticates the second entity based on the message.

34. The apparatus of claim 33, wherein the trusted entity authenticates the second entity based on verification of at least one of the vehicle manufacturer signature, the entity signature, and the entity manufacturer signature.

35. The apparatus of claim 27, wherein the trusted entity conveys a service grant to the second entity when the second entity is an authenticated entity.

36. The apparatus of claim 27, wherein the trusted entity generates a first random number and conveys, to the second entity, the first random number and a request that the second entity send a certificate comprising a vehicle manufacturer signature, wherein the second entity generates a second random number and conveys, to the trusted entity, a message comprising the first random number, the second random number, and the certificate having the vehicle manufacturer signature, and wherein the trusted entity authenticates the second entity based on the message.

37. The apparatus of claim 36, wherein the message further comprises an entity signature and an entity manufacturer signature.

38. The apparatus of claim 27, wherein, when the second entity is an authenticated entity, the trusted entity determines whether to reprogram the entity and, in response to a determination to reprogram the entity, reprograms the second entity with new software.

39. The apparatus of claim 38, wherein the second entity is a vehicle system that comprises vehicle system information and wherein the trusted entity retrieves vehicle system status information from the vehicle system and determines whether to reprogram the entity based on the vehicle system information.

40. The apparatus of claim 38, wherein, when the trusted entity reprograms the second entity, the second entity executes the new software to produce a result and conveys the result to the trusted entity, and wherein the trusted entity determines whether the reprogramming is successful based on the result.

41. The apparatus of claim 27, wherein the second entity is a vehicle system that comprises vehicle system status information and wherein, when the second entity is an authenticated entity, the trusted entity retrieves vehicle system status information from the vehicle system and sends the retrieved vehicle system information to the infrastructure.

42. The apparatus of claim 41, wherein, in response to sending the vehicle system status information to the infrastructure, the trusted entity receives new software and reprograms the second entity with the new software, wherein the second entity executes the new software to produce a result and conveys the result to the trusted entity, and wherein the trusted entity determines whether the reprogramming is successful based on the result.

43. The method of claim 41, wherein the vehicle system status information comprises at least one of a current date, a current time, a current location of the vehicle, a current mileage of the vehicle, a vehicle identification number, and an engine diagnostic code.

44. The method of claim 27, wherein the trusted entity generates a session key when the second entity is an authenticated entity and securely conveys the session key to the authenticated entity.
